(19) United States
(12) Patent Application Publication
(10) Pub. No.: US 2011/0008427 A1
(43) Pub. Date: Jan. 13, 2011

(54) Microcapsules and Methods

(75) Inventors: Simon Biggs, Leeds (GB); Richard Williams, Leeds (GB); Olivier Cayre, Leeds (GB); Qingchun Yuan, Leeds (GB)

Correspondence Address: CONLEY ROSE, P.C.;David A. Rose, P. O. BOX 3267, HOUSTON, TX, 77253-3267, US

(73) Assignee: UNIVERSITY OF LEEDS, Leeds, West Yorkshire (GB)

(21) Appl. No.: 12/679,196

(22) PCT Filed: Sep. 22, 2008
(86) PCT No.: PCT/GB2008/003197

§ 371 Date: Aug. 27, 2010

(30) Foreign Application Priority Data
Sep. 20, 2007 (GB) 0718300.7

(51) Int. Cl. A01N 61/00; B32B 1/06; B05D 1/12; A01P 15/00

(52) U.S. Cl. 424/463; 428/402.24; 427/180

(57) ABSTRACT

The present invention relates to microcapsules and methods for the production of microcapsules using sterically stabilized colloidal particles wherein the microcapsule comprises a core and a shell and wherein the shell comprises a layer of sterically stabilised colloidal particles and is characterized by the fact that the microcapsule has a mean size from 1 to 100 microns.

### CROSS-REFERENCE TO RELATED APPLICATIONS

This application is a 35 U.S.C. §371 national stage application of PCT Application No. PCT/GB2008/003197, filed 22 Sep. 2008, and entitled Microcapsules and Methods, hereby incorporated herein by reference, which claims priority to UK Patent Application No. 0718300.7, filed 20 Sep. 2007, hereby incorporated herein by reference.

### STATEMENT REGARDING FEDERALLY-SPONSORED RESEARCH OR DEVELOPMENT

Not applicable.

### BACKGROUND

The present invention relates to microcapsules and methods for the production of microcapsules. More specifically, the invention relates to microcapsules and methods for the production of same using sterically stabilized colloidal particles.

Active molecules such as drugs or pesticides are expensive to develop and manufacture. In addition, the application of such molecules often involves an indiscriminate single dosing that can lead to unwanted side-effects or the pollution of otherwise healthy tissue, organs or cells alongside the intended mode of operation at the targeted site of action. Likewise, the nature of the applications of cosmetics, personal care products and agrochemicals is such that the delivery of the often costly actives leads to the waste of the actives and/or environmental damage.

Consequently, routes that can provide the controlled delivery of active molecules to the intended site of action are much sought after. In addition, there are benefits that may be accrued from an ability to control the actual dosing rate of active molecules at the site of action. One proposed approach is the use of microcapsules that contain the active components isolated within a delivery matrix of microcapsules.

As a result of the need for effective delivery systems, the production of microcapsules for use in a wide range of industries such as agrochemicals, personal care products, pharmaceuticals, foods, pet foods and cleaning products is a rapidly increasing field of interest. The main drivers for the use of microcapsules in these applications are:
(a) the desire to effectively use and reduce the amounts of active chemicals used;
(b) the need to efficiently target the delivery and release of such active molecules; and
(c) the ability to overcome frequently encountered incompatibility between the active molecules and the chosen delivery matrix of microcapsules, especially when that matrix is a preferred water-based formulation.

In practice, the lack of suitable targeted delivery systems results in an over-dosing of the active molecules and therefore a large proportion of the active molecules employed are wasted. This is both costly and potentially harmful.

A further requirement of the delivery system of active molecules is that the microcapsules act to protect the active molecules from a hostile environment on the journey to the site of action, for example, the delivery of pharmaceutically active molecules through the gut to the point of release.

Despite the obvious interest in microcapsules, one commercial manufacture of microcapsules relies on an interfacial polymerization methodology whereby, the microcapsule wall is prepared in-situ by the reaction of two or more chemical monomers at an oil-water interface to form a polymer shell. This approach has been shown to be successful for the production of a limited number of microcapsules such as those where the coating is a melamine formaldehyde material. There are however drawbacks with this technique for example:
(a) there is the possibility for contamination of the active molecules by unreacted monomers, and;
(b) the reaction conditions for preparing microcapsules frequently require elevated temperatures that can be detrimental to many heat sensitive active molecules.

Other commercial techniques for the manufacture of microcapsules include: coacervation and suspension polymerization. These techniques however also have the inherent problems of complex reaction conditions, including the use of heating (suspension polymerization), and the presence of contaminants.

An alternative process which has recently been proposed involves the use of particle stabilizers as the building blocks for a new range of capsules, which are frequently referred to as ‘colloidosomes’, as described in U.S. Patent Application Publication No. 2004/0096515.

In the system described therein, particulates are used to stabilize the oil-in-water or water-in-oil system of interest (the active molecule is usually in the dispersed phase) known as Pickering emulsions.

These particle stabilized emulsions have a shell composed of particulates. The term ‘particulates’ is usually deemed to refer to colloidal solids, which are usually polymer latex, however, the term can also be used to describe inorganic oxides, ceramics, and metals.

The shells are rendered ‘permanent’ by one of the following:
(a) coagulation of the particles (by the addition of salt);
(b) sintering/fusion of the particles by heat treating; or
(c) binding of the particles using a high molecular weight polymer.

Such approaches have been demonstrated to be capable of producing robust capsule shells where some control over the porosity of the shell is possible. Whilst these methods are of interest, some limitations are also apparent for example:
1. The use of elevated electrolyte concentrations to coagulate the particle shells and thereby lock them into place can introduce an additional ‘pollutant’ into the system. A reduction of the stabilisation of the particles by the addition of salt may also lead to the coagulation of neighbouring capsules. Whilst this can generally be overcome by working at very low capsule concentrations such a procedure is uneconomical for the manufacture of such capsules on a large scale.
2. The locking of particles by melting requires the use of an elevated temperature that is above the glass transition point (Tg) of the latex particles used. In the case of polystyrene for example, this is approximately 105° C. The fact that this temperature is higher than that of the boiling temperature of water results in a complicated processing system and thereby limits the encapsulation of thermally sensitive active molecules. Whilst an alternative would be to use polymer particles with a lower Tg value, this may potentially lead to subsequent stability issues for the microcapsules during storage. Polymers with low Tg values are known to possess ‘tacky’ characteristics such that stored capsules adhere together over time.
3. When polymer bridging is employed, the nanoparticles are permanently confined to the droplet surfaces through high molecular weight polyelectrolyte chains adsorbing onto the external surface of the capsules by electrostatic action. Once again, this process can only be successfully undertaken at very low capsule concentrations to reduce the problems associated with bridging flocculation that ensues at the required concentrations, thereby again providing a significant handicap to commercial exploitation.

In procedures 1, 2 and 3 above, the degree of porosity of the shell of the capsules is very large and therefore it is doubtful that these systems would have the potential for the encapsulation of molecular materials such as active molecules. Each of the methods highlighted are carried out using complicated manufacturing protocols and the capsules can only be produced at very low droplet concentrations.

### SUMMARY

It is therefore the aim of the present invention to provide an encapsulation system that is more robust and less complicated than existing procedures and which can therefore provide colloidosome-inspired microcapsules in large quantities and higher concentration for industrial application.

It is a further aim of the present invention to provide a method of encapsulation that can also provide a means of adjusting the pore size of the microcapsule shell.

It is yet a further aim of the present invention to provide an encapsulation system that enables the structure and size of the colloidosome-inspired microcapsules to be controlled in order to meet the specific requirements of targeted release profiles.

According to a first aspect of the present invention there is therefore provided a microcapsule comprising:
a core; and
a shell, wherein
the shell comprises a layer of sterically-stabilised colloidal particles, and
characterized in that the microcapsule has a mean size from 1 to 100 μm.

The colloidal particles (also known as a nanoparticles) can be prepared from a wide range of available materials including but not limited to for example:

metals, such as for example gold, silver and tungsten; metal oxides, such as for example, alumina, silica and iron oxide; and organic lattices such as for example polystyrene and poly(methyl methacrylate).

However, according to the present invention, the colloidal particles prepared herein are preferably comprised of polymer latex particles.

The term steric stabilization used herein refers to the extra stabilizing power given to the colloidal particles by the presence of a soluble polymer block projecting out from the surface of the particles. This provides a ‘protective sheath’ around each colloidal particle thereby preventing any other colloidal particles from approaching too closely that might lead to instability of the particle dispersion and aggregation of the colloidal particles.

According to the present invention, one form of steric stabilization of the colloidal particles is by a steric stabilizer, preferably a physisorbed stabiliser (located on the shell of the colloidal particle) and comprises a polymer, for example but not limited to a homopolymer or a copolymer. Examples of suitable homopolymers include for example but are not limited to: poly(2-di-alkyl ethylaminomethacrylate) [alkyl substituents include methyl, ethyl, propyl, phenyl]; polyethylene oxide; polyethylene glycol; poly(acrylic acid); polyacrylamide; polyethylene imine; polyvinyl alcohol; carboxymethyl cellulose; chitosan; guar gum; gelatin; amylose; amylopectin; and sodium alginate.

Alternatively the stabiliser is comprised of an end-grafted stabilizer. End-grafted stabilizers are preferably prepared by either the ‘grafting from’ or ‘grafting to’ approaches.

In the case of ‘grafting from’ end attached stabilisers, it is necessary to functionalise the surface of the particles by covering them with initiator groups from which a polymer chain can be grown. A range of polymerisation methodologies have been employed for this type of reaction including: anionic, cationic, RAFT, ATRP, and controlled ring-opening schemes. In all cases, the choice of an appropriate initiator group that can be attached to the particle surface is often critical.

In the case of ‘grating to’ end attached stabilisers it is necessary to produce end-functionalised polymers wherein the functional group specifically reacts with surface active sites on the particles.

Suitable functional groups for producing the end-functionalised polymers depend on the surface functional groups of the colloid particles. Examples include: thiol terminated polymers for reaction with gold particles or carboxy-terminal polymers for reaction with surface hydroxyl groups on particles such as silica or alumina.

In both cases, whether grafting-from or grafting-to, the result is a chemically attached end-grafted polymer layer that sterically stabilises the particles.

More preferably however, the polymer comprises a copolymer, more specifically a block copolymer, and most preferably an AB block copolymer.

When the physisorbed steric stabilizer comprises, for example, a block copolymer, one of the blocks in the block copolymer has a high affinity for the surface of the colloidal particles whilst the other block has no affinity for the surface of the colloidal particles. Consequently, in the colloidal particles of the present invention, one block of the block copolymer is firmly attached to the shell surface whilst the other block projects away from the shell surface into the bulk of the solution. This technique is commonly referred to in the art as a physisorption method of adding steric stabilizers to colloidal particles.

In an alternative approach to producing sterically stabilized colloidal particles, the steric stabilizer may be present during the manufacture of colloidal latex particles using emulsion polymerisation wherein, one block may be incorporated into the outer shell of the particle (especially relevant to organic latex particles) whilst the other block extends away from the shell surface of the particle. The key feature of this approach is that one block must have a high affinity for the solvent whilst the other block has a high affinity for the reactive monomer oil droplets in the precursor emulsion.

One block of the stabiliser is soluble in the monomer oil such that as polymerization takes place forming the latex, the stabiliser essentially becomes ‘locked into’ the colloidal particle. Consequently the process is not so much a surface adsorption but rather the polymer is instead incorporated into the outer parts of the colloidal particle formed. This ultimately produces a stabilizer that is very strongly attached to the colloidal particles. As a result of this process there is a region of the colloidal particles (or micro-particles) at the outer layer that comprises different composite material properties to that of the bulk of the micro-particles. Whilst not wishing to be bound by any particular theory it is thought that this region is one which comprises a lower Tg value and thereby allows the surface of the micro-particles to experience so called ‘melting’ at a different temperature to the bulk of the colloidal particles. By ‘melting’ in this context is meant a temperature above the glass-transition where chains can inter-diffuse and ultimately neighbouring particles can fuse together.

It is thought that this variation in Tg of the micro-particles through the steric sheath thus allows fusion of the microcapsule shell at reduced temperatures.

It will be appreciated to one skilled in the art that since AB Block copolymers are polymers that consist of two linked polymers (so linked at a single junction), one consisting of monomer A and the other consisting of monomer B, that variation in the properties of the copolymer can be obtained by variations in the monomers utilized. That is, depending on the nature of the monomers selected, the copolymers will have different chemical properties, the molecular weights of the copolymer (at a fixed ratio of the two component block sizes) will also vary, as will the ratio of the molecular weights of the constituent blocks (at a fixed overall molecular weight for the copolymer). Therefore, the selection of different molecular weight monomers for use in the block copolymers allows for a form of ‘tuning’ with regard to how close the colloidal particles can approach one another as a result of the size of the monomer block protruding from the surface of the particle shell. Consequently, the spacing between the particles and hence the pore spacing within the microcapsule shells that are the subject of the present invention can be controlled.

Preferably, the portion of the block copolymer that protrudes from the particle surface, referred to herein as the steric stabiliser block of the copolymer comprises a reversible hydrophilic/hydrophobic character that can be varied by altering the physical conditions. This allows a transition between a fully extended polymer (providing maximum stabilization power) through to a fully collapsed polymer chain (providing no stabilization power). Importantly, changes in the relative solubility between these limits can allow the ‘tuning’ of how much the polymer collapses and hence how close the particles may approach.

It is however preferred that all polymer types used according to the present invention whether grafted or physisorbed and whether copolymer or homopolymer are stimulu responsive.

In accordance with the present invention the steric stabilizer preferably comprises extensions of between 5 nm and 500 nm.

It will be also appreciated by one skilled in the art that the component monomers within the copolymer may be dispersed randomly, alternately or in blocks. Preferably however, the copolymer is a block copolymer. The block copolymer may further be selected from for example but not limited to: AB blocks, ABA blocks, ABC blocks, comb, random, ladder, and star copolymers. Most preferably however, the block copolymers comprise AB block copolymers or random copolymers for example an “A block” (that is a copolymer comprising monomer A and another monomer C) and the steric stabilising B block.

It is also preferred that the block copolymers include blocks that are capable of being adsorbed at the target surface. For example is it possible to utilize reactive monomers to allow chemisorption through a chemical reaction such as condensation. This mechanism is also relevant for end-functionalised polymers for use in the ‘grafting to’ process described previously. Suitable functional monomer groups will be dependent also on the surface of the particle. For example, thiol groups (SH) react excellently with gold giving a gold sulfur link that is chemically very stable. For silica surfaces, the use of reactive SiH [silane] groups is preferred.

It is also preferred that the block copolymers are sensitive to a stimulus. Preferably, the stimulus includes one or more of for example changes in pH, changes in temperature, humidity, changes in the wavelength of light, or the absence thereof, ionic strength and electrical and magnetic fields.

It is preferred that for the AB block copolymers comprising the steric stabilizers for use in the microcapsule(s) of the present invention that it is the steric block that is responsive to a stimulus. The attachment block of the copolymer does not however need to be responsive to a stimulus.

The AB block copolymers used in the present invention typically respond to stimuli such as: humidity, pH, ionic strength, temperature, light, electrical and magnetic fields.

Furthermore, the AB block copolymers utilized in the present invention may respond to a single stimulus system or alternatively, may respond to more than one stimuli.

Preferred stimuli according to the present invention comprise pH and/or temperature.

Examples of available monomers that can be utilised in the AB block copolymers of the present invention but not limited thereto include for example;
(a) pH sensitive polyelectrolytes: selected from a group that includes but not limited to for example: dialkyl aminoethyl methacrylates where the alkyl groups include but are not limited to methyl, ethyl, propyl, benzyl. It should be noted that the alkyl groups may be either symmetric or asymmetric at the amino centre, and that the nature of the alkyl group is not limited and that the alkyl groups may be further substituted by other groups such as for example fluorine;
chitosan, polyacrylic acid, polyacrylamides and derivatives thereof, polymethacrylic acid, polysodium acrylate, polystyrene sulfonate, polysulfanamide, poly(2-vinyl pyridine), poly(vinylpyridinium bromide), poly(diallyldimethylammonium chloride) (DADMAC), poly(diethylamine), poly(epichlorohydrin), polymers of quarternised dialkylaminoethyl acrylates, poly(ethyleneimine) and polyglucose amine.
(b) pH sensitive polysaccharides: wherein the polysaccharide is selected from the group consisting of but not limited to: xanthan, carragenan, agarose, agar, pectin, gellan gum, guar gum, starches and alginic acid. Preferably, the polysaccharide is a derivatised polysaccharide selected from the group consisting of carboxymethylcellulose and hydroxypropylguar.
(c) temperature-sensitive polymers: wherein the temperature sensitivity is such that the polymer is either substantially soluble or substantially insoluble at low or high temperatures. The temperature sensitive polymers are preferably selected from the group consisting of but not limited to: poly(N-isopropylacrylamide) (poly(NIPAM)); co-polymers of polyNIPAM in combination with polymers such as for example polyacrylic acid, poly(dimethylaminopropylacryl-amide) or poly(diallyldimethylammonium chloride) (DADMAC), polyethylene oxide, polypropylene oxide, methylcellulose, ethylhydroxyethyl cellulose, carboxymethyl cellulose, hydrophobically modified ethyl hydroxyethyl cellulose, polydimethylacrylamide/Ar-4-plienylazoplienylacrylamide (DMAAm) and polydimethylacrylamide/4-phenylazophenylacryate (DMAA) and derivatives thereof, gelatine, agarose, amylase, agar, pectin, carragenan, xanthan gum, guargum, locust bean gum, hyaluronate, dextran, starches and alginic acid.

Most preferably the temperature sensitive monomers selected for use as copolymers in the colloidal particles according to the present invention comprise methylcellulose or poly(NIPAM).
(d) Photosensitive polymer molecules: examples include but are not limited to, polypeptides selected from the group consisting of for example lysine and glutamic acid; polyacrylamides, polysaccharides, polyelectrolytes and other water-soluble molecules. The photosensitive molecules can also include spyropyrans and/or, spyrooxazines. Examples of spyropyrans and/or spyrooxazines include for example benzoindolino pyranospiran (BIPS), benzoindolino spyrooxazine (BISO), naphthalenoindolino spyrooxazine (NISO) and quinolinylindolino spyrooxazine (QISO). Further photosensitive molecules include azo benzenes and derivatives thereof, as well as triphenyl methane and derivatives thereof.

The photosensitive molecule can be triggered by a change in the wavelength of light from substantially visible to substantially ultraviolet. Polymers responsive to a change in wavelength are selected from the group comprising: poly dimethylacrylamide/N-4-phenylazophenyl-acrylamide (DMAAm); poly dimethylacrylamide/4-phenylazophenylacryate (DMAA) and analagous polymers.
(e) Non-ionic (non-stimulus responsive) polymers may also be used to form one of the blocks of the copolymers however, when non-ionic (non-stimulus responsive) polymers are employed the other block of the block copolymer is required to be stimulus responsive. Examples of water soluble non-ionic polymers include for example polyethyleneoxide.

Preferred stimulus responsive monomers/polymers for use in the copolymers of the present invention comprise: poly(2-dimethylaminoethyl methacrylate)-b-poly(2-diethylaminoethyl methacrylate) [PDMA-b-PDEA], or poly(2-dimethylaminoethyl methacrylate)-b-poly(methylmethacrylate) [PDMA-b-PMMA], or poly(2-dimethylaminoethyl methacrylate)-b-poly(methacrylic acid) [PDMA-b-PMAA].

However, the most preferred stimulus responsive monomers/polymers for use in the copolymers forming the steric stabilizers in the colloidal particles of the present invention comprise PDMA-b-PMMA; and the preferred mode of stimulus is via pH.

It is a further object of the present invention to produce microcapsules comprising sterically stabilized colloidal particulates that are size controlled. It is to be understood that in the present invention the size control is a pre-requisite for many of the envisaged applications of the invention. For example in drug delivery, the passage across biological membranes or cell walls is only possible for certain sized materials. Furthermore, the strength of shell wall depends not only on the thickness but also on the overall capsule size such that at a given wall thickness, larger capsules will fracture more easily.

Therefore, it will be appreciated that good size control is vital to maximizing the potential applications for the present invention.

It is yet a further object of the present invention to produce size-controlled microcapsules on batch scales, in quantities of greater than 1 litre. In the present invention, the mean size of the microcapsules is 1 to 100 μm. More preferably the mean size of the microcapsules is 1 to 20 μm.

The mean size of the microcapsules is achieved through the use of a controlled emulsification procedure such as: cross-membrane or rotating membrane emulsification, micro-channel emulsification or capillary extrusion techniques.

For larger droplet sizes that is, greater than 20 microns, rotating membrane emulsification is preferred. For smaller sizes cross membrane emulsification is preferred.

Both approaches work by forcing the disperse phase liquid out through pores of a controlled size into a continuous phase including a stabiliser (in this case the particles that comprise the microcapsule shell wall). The shear field (caused by liquid being forced to flow over the static membrane surface in cross-flow or by the moving membrane rotating in a static fluid in the rotating membrane system) assists in the detachment of the drops from the membrane. The membrane preferably comprises a regular array of pores all of which are the same size allowing the production of regular sized droplets.

Stabilisation of the droplets requires that the particles are surface active. The contact angle of the particles at the water-oil interface determines whether an oil-in-water or water-in-oil system is preferred. If the contact angle at an oil-water interface is less than 90° then an oil-in-water system is preferred. This is the preferred case for the present invention.

To date, there are no reports of microcapsules with mean sizes of less than 10 μm. Furthermore, good size control is reported only in a highly specialized micro-channel flow emulsifier capable of producing only a few ml of product. (Xu et al. Colloids and Surfaces A: Physicochem. Eng. Aspects 262 (2005) 94-100).

As discussed above, the microcapsules of the present invention represent a ‘smart capsule system’, that is a system of microcapsules that are able to respond to an external stimulus to release their contents. In the present invention, this has been achieved by the use of sterically stabilized particle emulsifiers where the steric stabilisers can be subsequently chemically cross-linked. The choice of cross-linking agent is dependent on the specific chemistry of the homopolymers or copolymers being used as steric stabilizers. Examples include but are not limited to: sodium hydroxide (NaOH) or divinylsulfone (DVS) as cross-linking agents for ethyl(hydroxyethyl) cellulose (EHEC); boric acid to cross-link guar gum; and glutaraldehyde for polyvinyl alcohol (PVA).

The steric stabilizers ideally possess specific stimuli-responsive functionality such that the microcapsules, when formed by the cross-linking process, are able to expand and collapse as a function of external stimuli such as: pH; ionic strength or temperature.

If this expansion/collapse response is reversible, for example by repeated pH cycling causing charge/discharge of a polymer chain and hence expansion/contraction cycles, then the capsule can be made to ‘breathe’ through repeated cycles of expansion and contraction that will expand and contract the capsule wall. If one thinks of the microcapsule system as a string bag, that can expand and collapse, then the colloidal particles are ‘dotted’ all over the string bag and provide mechanical strength (FIG. 7). This system allows for the possibility to actively pump the contents out of the microcapsules as well as providing a mechanism for triggering the release of the contents of the microcapsule by expanding the ‘porosity’ of the colloidal particle shell.

Another feature of the microcapsule system of the present invention is that by controlling the size of the steric stabilizers, the inter-particle spacing can be controlled.

Larger spacings will allow larger pores and hence faster release rates.

In addition, by varying the size of the particles (as a ratio to the size of the steric stabilizers) this provides a means of producing a high degree of control over the porosity of the microcapsule.

Finally, by using a wide range of potential colloidal particle and steric stabilizer chemistries, it is possible to obtain a high degree of control on the microcapsule shell properties.

Previous teachings have involved a permanent locking of the particles on the capsule wall and no inherent reversibility of the porosity through a so-called ‘breathing’ mechanism as described above. The chemical cross-linking method of the present invention allows the production of single layered stimulus responsive soft shells, which have potential for use in the triggered release of a wide range of active encapsulants including larger encapsulants such as cells. Use of a disperse phase soluble cross-linking agent allows the production of capsules at relatively high droplet concentrations, typically up to 60% by volume compared with less than 0.1% in earlier work. Consequently, by linking from the inside it is possible to operate at very high droplet concentrations many orders of magnitude higher than those already described making a commercial manufacture process viable.

It is also a key point of the present invention that the use of a steric stabiliser provides a polymer that can have a low Tg and hence fuse at temperatures well below those of the core colloidal particles. This is important because heating usually damages active molecules. Preferred Tg values are typically in the range of from 5 to 90° C., more preferably 30 to 50° C.

Whilst latex particles could be made with low Tg for use as surface-active particles in colloidosome-inspired capsule manufacture, this is not feasible for inorganic or metal particles. Therefore, the surface steric ‘film’ may provide an alternative route to fusion of the shell in these cases. This is also the case for high Tg polymer lattices such as polystyrene. By only fusing the outer steric shell it is possible to retain the mechanical properties of the main particles giving good strength (and controllable properties) to the microcapsule shell wall.

Finally, the present invention provides a system that can fix the particles on a disperse droplet by heat treatment at a temperature lower than 100° C. The procedure can therefore be conducted in both a simple aqueous oil/water system and water/oil system. Whilst permanent binding of the particles via heat treating and melting of the particles has been proposed, the materials chosen typically had a Tg value higher than 100° C. Higher Tg (>60° C.) values are preferred for mechanical strength at room temperature but require a high-melting temperature to generate fusion. This can be detrimental to many actives of interest. By using a sterically stabilized particle system, it has been found that multiple phase transition temperature are achievable so that it is possible to fuse the colloidal particles at considerably lower temperatures whilst still retaining the core high Tg materials for mechanical strength.

In the present invention three Tg values were observed for a sterically stabilised latex particle: these values arise from the nature of;
(a) the steric polymer sheath;
(b) the outer part of the particle where there is a mixed zone of the PS particle and the PMMA block of the copolymer which is embedded; and
(c) the PS core particle.

A key feature of the present invention is that (a) and (b) are lower than (c).

Also observed in the present invention is a reduction in the Tg from 105° C. (for PS particles) to about 75° C. for the steric polymer sheath. An intermediate Tg at approximately 85° C. was also seen for the PMMA/PS region at the outer part of the particle.

In the case of latex stabilised in this way by an embedded block of a block copolymer stabiliser, it is possible to tune the degree of fusion by adjusting the temperature and the time over which it is applied. This allows some control over the system porosity and eventual mechanical properties.

Therefore, the presence of the steric stabilizer results in a reduction in the temperature needed for fusion of the particles as a result of the composite nature of the particles.

According to a second aspect of the present invention there is provided a method of producing microcapsules using sterically stabilized colloidal particulates as the primary building blocks comprising the steps of:

preparing an emulsion through the addition of a first liquid to a second liquid such that the first liquid forms droplets dispersed within the second liquid;

coating the dispersed droplets with sterically stabilized particles whereby the colloidal particulates act as a stabiliser of the liquid-liquid interface; and

securing the sterically stabilized particles on the surface of the droplets to form a system of microcapsules.

The sterically stabilized particles are secured in place on the surface (or shell) of the droplets by either heat treatment or chemical cross-linking of the steric stabilizer polymers.

When heat treatment is the preferred method, the preferred temperature range is between 70° C. and 80° C. The preferred stabilizer comprises PDMA-b-PMMA on the polystyrene (PS) latex system.

The preferred droplet concentration is less than 5% by volume, in order to prevent aggregation between multiple particle stabilised oil droplets.

When chemical cross-linking is the preferred method, an internal cross-linking method is employed which fixes the nanoparticles in place as a single layer on the shell or surface. A preferred cross-linking compound comprises 1,2-bis(2-iodoethyloxy)ethane, which is insoluble in water.

Before the emulsification step takes place, a known amount of the preferred cross-linker compound is dissolved in the oil phase. The advantages of employing the internal cross-linking method are that it is possible to carry out the method using high droplet concentrations. For example, droplet concentrations of 60% or higher by volume may be used.

It will be appreciated by one skilled in the art that the exact nature of the cross-linking compound will depend upon the type of steric stabiliser employed and also whether the system employed is a water-in-oil or oil-in-water emulsion.

Consequently, the use of the sterically stabilized particles applied to the surface of the oil droplets form a stable emulsion. This applies when the emulsion is an oil in water (o/w) or a water in oil (w/o) emulsion. Furthermore, the above method can be applied to oil-in-oil emulsions where the two oils are themselves immiscible.

In the present application the use of the term ‘stable’ is used herein to mean that the droplets do not break down or aggregate in a time scale of relevance. For example, in the present invention the emulsion may be required to be stable for 24 to 48 hours prior to the commencement of the cross-linking reaction. After the cross-linking or heat treatment stage has taken place, the system is indefinitely stable since the particles are no longer able to leave the interface.

In the present method according to a second aspect of the present invention, the affinity of the sterically stabilized particles for the surface of droplets is controlled by the relative wettability of the sterically stabilized particles within either phase. A contact angle of 60° to 90° is preferred for the formation of an oil-in-water emulsion.

In addition it is preferred that the particles are dispersed in the continuous phase prior to emulsification.

Consequently, by using the method according to the second aspect of the present invention it is possible to produce microcapsule emulsions. Therefore according to a second embodiment of the second aspect of the present invention there is provided a method of producing microcapsule emulsions comprising the steps of:

(i) preparing an emulsion comprising droplets;
(ii) stabilizing the droplet emulsion by means of colloidal particulates, followed by;
(iii) linking the particles together to form microcapsules.

The membrane emulsification stage of step (i) above has the effect that the size of the droplets can be controlled. Consequently, the size of the microcapsules can also be controlled as a result of steps (ii) and (iii) above.

In the method according to the second aspect of the present invention, if the process of chemical cross-linking achieves the linking of the particles, then the resultant micro-capsules are referred to as ‘soft-shell’ capsules. This term means that when solvent is removed from the microcapsules the microcapsules collapse as evidenced using SEM imaging.

Alternatively, if the method utilizes heat-treating in order to effect the linking of the particles, then the resultant microcapsules are referred to as ‘hard-shell’ microcapsules. The term ‘hard-shell’ refers to the fact that when the solvent is removed from the microcapsules the microcapsules do not collapse, as seen using SEM imaging.

Microcapsules prepared using the method according to the second aspect of the present invention comprise colloidal particles that:
(i) retain the inherent properties of the core particle which has not itself undergone fusion; and
(ii) allow fusion to take place at much reduced temperatures thereby allowing heat-sensitive ingredients to be incorporated into the microcapsules.

Furthermore, the method allows the porosity of the microcapsule shell wall to be controlled by means of variation of particle concentration and the time and/or temperature of the fusion reaction.

Alternatively, the method according to the second aspect of the present invention can be used to prepare ‘soft shell’ microcapsules from emulsions produced using sterically stabilized colloids (nanoparticles) where the sterically stabilised colloid particles are chemically cross-linked by the reaction of the steric stabilizers.

‘Soft-shell’ microcapsules refers to microcapsules which collapse as evidenced using SEM imaging when the solvent is removed.

Consequently, in order to prepare ‘soft-shell’ microcapsules, the method according to the second aspect of the present invention further comprises the step of:

adding a chemical cross-linking agent to the emulsion.

Most preferably the chemical crosslinker comprises 1,2-bis(2-iodoethyloxy)ethane, which is insoluble in water.

Furthermore, it is preferred that the chemical cross-linker has no solubility in the continuous phase.

It is also most preferred that the reaction that cross-links the sterically stabilized particles occurs from within the droplets allowing the production of microcapsules at high volume fraction of emulsion droplets.

That is, by carrying out a reaction from the inside of the microcapsule, only reactive groups within each droplet are able to react together. If the reaction were performed from the outside, then it would be possible for chains on two neighbouring droplets to react together linking them to one another. Essentially the inside of each droplet is shielded from another droplet whilst the outside parts are interacting.

It will be further appreciated by one skilled in the art that the above method may be applied to oil-in-water, water-in-oil, or oil-in-oil emulsions as long as:

(a) the two phases are immiscible;

(b) the chemical cross-linker is soluble only in the dispersed phase; and

(c) the emulsion produced can be stabilized by an assembled layer of the sterically stablised particles.

Furthermore, in the method of producing ‘soft shell’ microcapsules described above the sterically stabilized particles are “stimulus-responsive”. As mentioned in the first aspect of the present invention, suitable stimuli include: temperature, pH, salt concentration, light, electricity and magnetic fields. A response to a stimulus will have the result that the shell of the microcapsules effectively contracts or expands leading to an increase or decrease in the porosity.

The method described above can be used to prepare microcapsules that are capable of encapsulating a wide variety of active materials. For example the active material may comprise an active material that is soluble in the dispersed phase of the emulsion; or the active material may itself comprise an oil that can also act as the disperse phase. Furthermore, the active material may comprise a particulate that can be dispersed in the disperse phase; or an active material that comprises a bio-molecule that is dispersible in the disperse phase; alternatively, the active material may comprise a natural oil that can act as the disperse phase; or the active material may comprise a cellular organism.

The microcapsules according to the present invention are suitable for use in a range of industrial applications for example but not limited: the cosmetics industry, personal care products, homecare and cleaning products, agrochemicals, paints and coatings, and pharmaceutical formulations. Consequently, the microcapsules may further comprise components such as for example: additives, biocides, perfumes, colourants etc as required by the particular field of application. It will however be appreciated by one skilled in the art that this list is by no means exhaustive.

It is envisaged that in any of the fields of interest listed above that in most cases the active will either be soluble in the disperse phase (usually oil but sometimes water) or will itself be an oil. Occasionally however, the microcapsules may be utilised in water-in-water or oil-in-oil systems.

### DESCRIPTION OF THE DRAWINGS

The invention will now be further illustrated by way of the following examples in which all parts are by weight unless otherwise stated, and by way of FIGS. 1 to 20 wherein:

FIG. 1—illustrates the volume average and the number average size distribution data for mineral oil oil/water emulsions prepared using a fixed amount of sterically stabilized colloidal latex particles.

FIG. 2—illustrates a graph of the differential scanning calorimetric (DSC) analysis of nanoparticles.

FIG. 3—illustrates an optical micrograph of colloidosome-inspired microcapsules dispersed in water (oil/water emulsion heat treated at 86° C. for 5 minutes.

FIG. 4—illustrates a scanning electron micrograph (SEM) image of the colloidsome microcapsules of FIG. 3 after coating with gold under high vacuum.

FIG. 5—illustrates an optical micrograph of crosslinked colloidosome-inspired microcapsules dispersed in water.

FIG. 6—illustrates a scanning electron micrograph (SEM) image of a microcapsule of FIG. 5.

FIG. 7—illustrates a scanning electron micrograph (SEM) image of the arrangement of nanoparticles on colloidosome-inspired microcapsules of FIG. 5.

FIG. 8—illustrates a single pass crossflow membrane emulsification system for the preparation of colloid stabilised emulsions.

FIG. 9—illustrates an emulsion produced using XME with a ceramic membrane of 0.5 μm.

FIG. 10 illustrates the hydrodynamic diameter of hybrid colloidal systems in water at pH 4, consisting of 20 nm diameter gold nanoparticles grafted with the 4 homopolymers of increasing molecular weight and the diblock copolymer presented in Table 2.

FIG. 11 illustrates the surface tension measurements as a function of pH for 20 nm gold nanoparticles grafted with a layer of p[DMAEMA]28 on the surface.

FIGS. 12a and 12b illustrate optical microscope images recorded 5 minutes after homogenisation of oil-in-water emulsions prepared in the presence of 20 nm gold nanoparticles coated with p[DMAEMA]28 homopolymer. In both cases the aqueous phase is at pH 10 to facilitate the adsorption of particles at the oil-water interface. Particle concentration in the aqueous phase is 0.03 wt % (a) and 0.3 wt % (b), respectively.

FIG. 13 illustrates a graph plotting the calculations of energy of desorption of bare nanoparticles at a typical oil-water interface (36 mN/m) as a function of their contact angle for three different particle diameter.

FIGS. 14a and 14b there is illustrated two images demonstrating variations in crosslinking.

FIGS. 15a and 15b illustrate optical images of the same sample of emulsion droplets stabilised by responsive polymer-coated latex particles redispersed at different pHs.

FIG. 16 illustrates a fluorescent microscopy image of microcapsules produced from an oil-in-water emulsion stabilised by polymer-coated latex nanoparticles.

In FIG. 17 illustrates an optical image of a microcapsule in Isopropyl-alcohol (IPA)/Water mixture (1:1 volume ratio) after complete removal of the oil from within the capsule core.

FIG. 18 illustrates an optical image of a microcapsule after complete removal of the oil phase and redispersion in aqueous phase containing 0.1 mM of a 70,000 g·mol⁻¹ dextran molecule labelled with a fluorescent dye.

In FIG. 19 there is illustrated a fluorescent optical image of the same microcapsule as in FIG. 18 after complete removal of the oil phase and redispersion in aqueous phase containing 0.1 mM of a 70,000 g·mol⁻¹ dextran molecule labelled with a fluorescent dye.

FIG. 20 shows fluorescent molecules adsorbed in the oil within capsules.

### DETAILED DESCRIPTION OF THE EMBODIMENTS

### 1. Emulsification

Standard homogenisers (rotor-stator type and other derivatives) and mixers may be used for the production of emulsions. For high precision emulsions, the use of cross-membrane, rotating membrane, and microchannel emulsifiers can be employed.

In this present invention oil/water emulsions were used as the base substrates for the preparation of the particle stabilised emulsions. The oils used included a medium liquid white oil (Batch No. 320352), dodecane (available from Fluka, at greater than or equal to 98.0% purity), vegetable oil such as sunflower oil and perfume oil). It will be appreciated that in principle, any oil may be used, the choice of sterically stabilised particle will to some extent be dependent on the choice of oil/water system to be stabilised.

In all cases, the emulsions may be prepared across a wide range of droplet volume fractions from 0.1 to 60%. Typical operating conditions depend on the method chosen and can be specified for one or all of them.

Any suitable standard approach for the emulsification technique is applicable and is considered to be within the scope of this application. Examples include micro-homogenisers or high-shear mixing devices.

High precision cross-membrane and rotating membrane approaches have not previously been reported for applications as described herein.

### 2. Locking of Particle Shells

Two methodologies for the locking of the particle shells are described:
(a) Locking by heating: A sample of emulsion (2 ml) was diluted to 20 ml in deionised water and then heated at a known temperature (from 75° C. to 90° C.±2° C.) under gentle stirring for 5 minutes. The reaction was then quenched by cooling rapidly under a steady flow of tap water across the reaction vessel.
(b) Locking by chemical cross-linking: An internal cross-link method was developed to fix the nanoparticles in place as a single layer. The cross-linker 1,2-bis(2-iodoethyloxy)ethane which was used is not soluble in water. Before the emulsification, a known amount of the cross-linker was dissolved in the oil phase. The emulsions produced were highly stable and were kept at room temperatures for a few days to allow the cross-linking reaction to reach completion. The cross-linking agent of choice here was used, as it has virtually no solubility in the continuous phase. Other cross-linkers may be available to fulfil this criterion. The key point at issue is to cross-link from the inside thereby allowing the reaction to be undertaken at substantial oil droplet volume fractions meaning that a high concentration of capsules can be produced.

### 3. Investigation into the Size Control of Emulsion Systems

The crossflow emulsification system (1) as shown in FIG. 8 which comprises a disperse phase tank (2) and continuous separation and circulation system (3), is designed for use on a single pass system. In this system, the continuous stream that comes out from the membrane module (4) is led to the separation tank system (3). In the system, the droplets either cream up or deposit to be separated out. Only the colloidal suspension is circulated back by pumping (5) to the membrane module. This procedure is adopted to maintain the individual disperse droplets formed from the detachment and stabilised by the nanoparticles.

FIG. 9 illustrates the droplets produced using a 0.2 μm ceramic membrane. The droplets have average sizes of approximately 10 and 30 μm, respectively. The droplets are smaller and have much more uniform size distribution than those prepared by homogenisation.

TABLE 1

| | Ceramic | Continuous | | | Running | |
|---|---|---|---|---|---|---|
| | membrane | phase | ΔPtm | Vcf | time | Oil consumed |
| Col- | 0.5 μm | 2 wt % Sterically | 0.15 MPa | 450 L/hr | 15 minutes | Ca 300 ml |
| 001 | | stabilsed larex | | | | |
| | | suspention, | | | | |
| | | pH = 9 | | | | |
| Col- | 0.2 μm | 2 wt % Sterically | 0.15 MPa | 300 L/hr | 90 minutes | Ca 180 ml |
| 002 | | stabilsed larex | | | | |
| | | suspention, | | | | |
| | | pH = 9 | | | | |

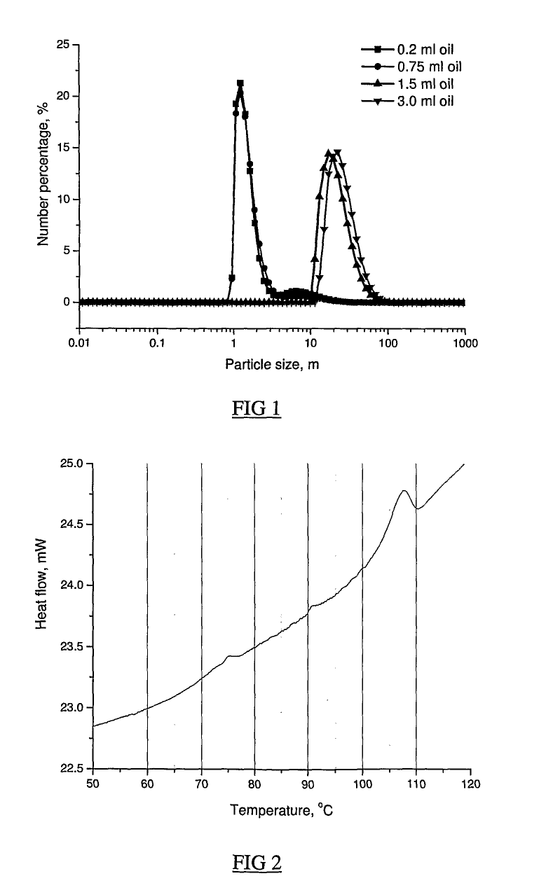

The size control of the emulsion systems was investigated by varying the ratio of the amount of oil to latex particle used. FIG. 1 illustrates the volume and number size distribution data for emulsions prepared using different quantities of mineral oil (0.2, 0.75, 1.5 and 3 ml) at a fixed amount of latex suspension (3 ml). It can be seen that both the mean droplet size and the size distribution alter as a function of the oil quantity used. As the oil amount is increased the mean droplet size is seen to increase, as expected, whilst the polydispersity is seen to decrease. At the lower oil values, the emulsions produced appear to show evidence of a bimodal size distribution. When the amount of oil used increases to between 1.5 and 3 ml, the emulsions are monomodal in size distribution and have larger droplets of approximately 40 μm in volume average and 25 μm in number average. These results clearly indicate that the mean size of the base emulsion system can be adjusted by varying the concentration ratio of oil and latex particles in the system.

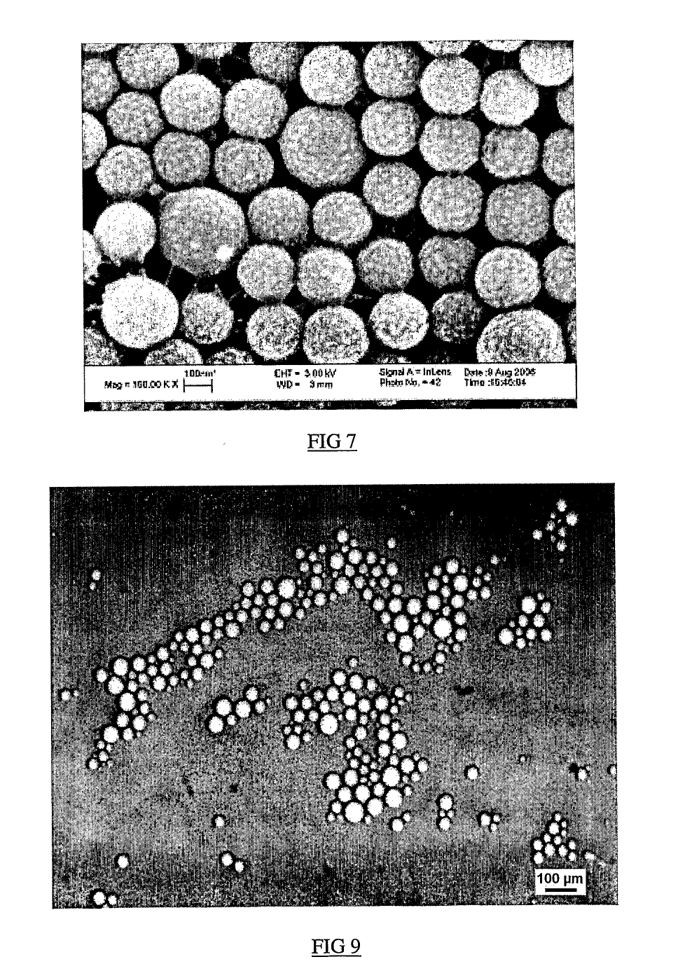

An emulsion prepared using 1.5 ml of mineral oil and 3 ml of latex suspension was divided into smaller aliquots and the samples were subsequently heat-treated at temperatures ranging from 75° C. to 92° C. Optical microscopy of the samples showed that when the temperature used was greater than 90° C., as shown in FIG. 7, large fused polymer agglomerates were produced. Visual examination of the sample also indicated the presence of large white coagulum in the sample. An analysis of the sterically stabilised latex particles using differential scanning calorimetry (DSC) (FIG. 2) showed that the particles have a major phase change at a temperature of approximately 107° C., which is consistent with the expected glass transition for polystyrene. In addition, the data also indicated the presence of two other phase changes at 75° C. and 90° C.; these transitions are assumed to relate to the presence of the grafted PDMA-PMMA chains. These transitions are consistent with the lower fusion temperature values observed in this investigation and suggest the presence of a surface or interfacial region of the particles that can fuse below the bulk glass transition temperature for polystyrene. When the heating temperature was reduced below 90° C., the originally formed emulsion droplets were seen to remain as discrete objects with a clear interface in water.

Two further temperature values were selected for investigation of the nanoparticles, namely, 86° C. and 75° C. In both cases, colloidosome-like microcapsules were produced although initial investigations suggest that the shell formed at 86° C. is stronger than that produced at 75° C.

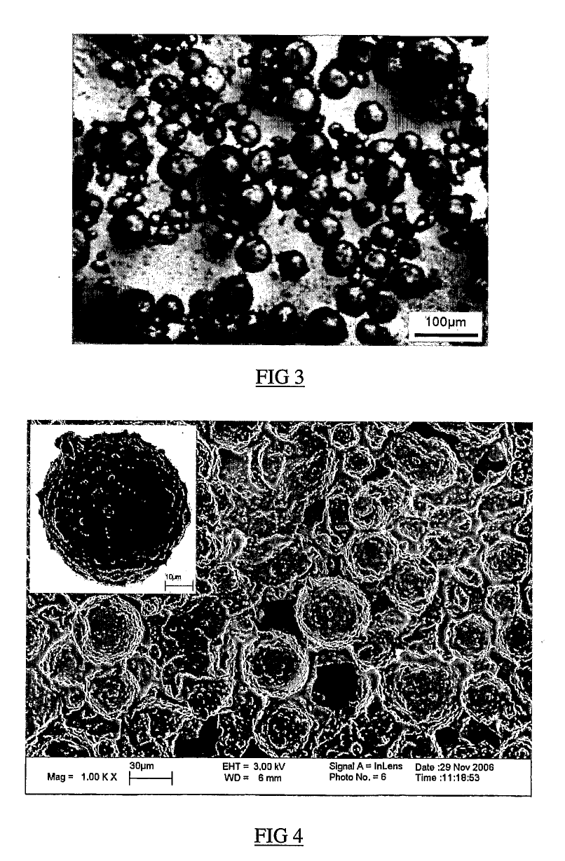

FIGS. 3 and 4 illustrate the optical and electron micrographs for a microcapsule sample produced at 86° C. After manufacturing, a sample of the microcapsules was dried and in the case of the electron microscope a sample also experienced a high vacuum.

From FIG. 3 it can be clearly seen that the individual microparticles are essentially spherical when in dispersion and have a solid structure that resists collapse upon drying. Higher resolution electron micrograph images further indicate that the wall consists of fused latex particles where the size/shape of the original particle stabilized (PS) disperse droplets is essentially retained. This provides further support for a fusion process that is dominated by the copolymer rich interfacial region.

A closer examination of FIG. 4 indicates that the capsules have a core/shell structure and the wall itself seems to consist of more than one particle layer. The inset of FIG. 4 shows a single microcapsule where the high vacuum has resulted in the oil contents boiling and bursting the wall (top left corner of inset). This suggests that the wall has an inherent strength that is not easily ruptured.

Dodecane was used as the oil phase in the preparation of colloidosome-inspired microcapsules via a chemical cross-linking method. The cross-linking agent was dissolved in the oil phase before being emulsified into the aqueous latex containing phase. In this way, it was hoped that only the nanoparticles assembled onto the oil droplet surfaces could react with the cross-linker from the oil phase. This approach ensured that only one layer of nanoparticles was locked into the colloidosome-like structure after reaction. As a result of this reaction process, there was no need to separate free nanoparticles from the oil droplet, or to dilute the emulsion to avoid the aggregation of microcapsules during the cross-linking reaction. Hence, it was shown that it is possible to produce microcapsules at high concentrations.

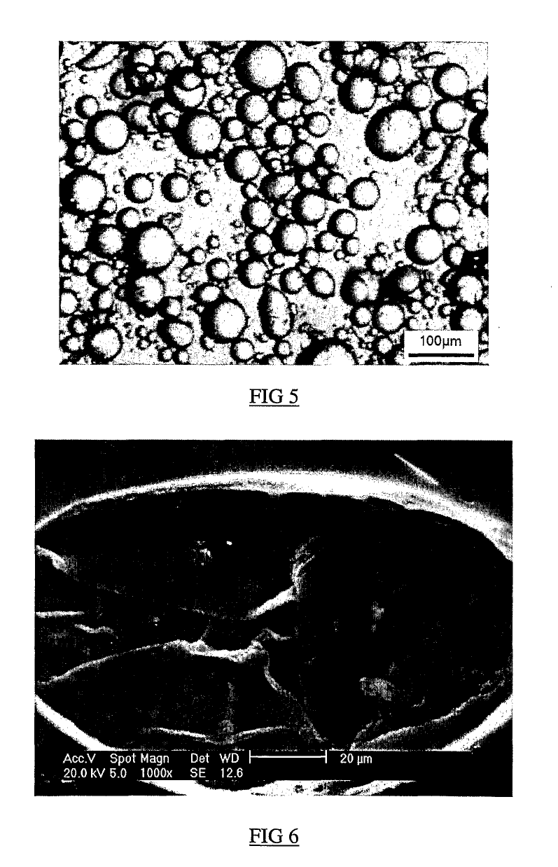

FIGS. 5, 6 and 7 illustrate the cross-linked colloidosome-inspired microcapsules and their wall structure. In FIG. 5 there is shown an optical micrograph of the capsules suspended in water. Once again, one can observe the presence of essentially spherical capsules having a definite interface with the continuous phase.

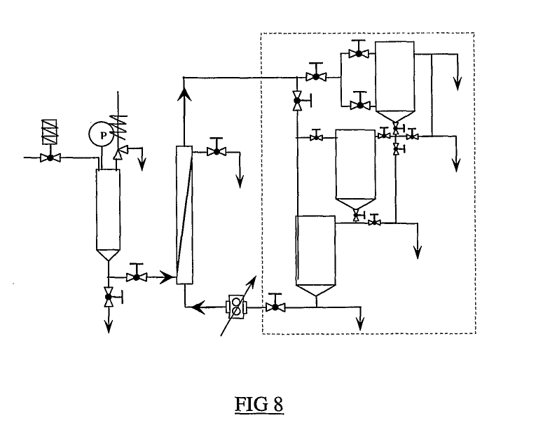

In FIG. 6, an electron micrograph of a single capsule after drying under vacuum is illustrated. Clearly, in this case the capsule has collapsed completely. This image suggests that the wall has considerably less structural strength than the heat-treated sample shown in FIG. 3.

In FIG. 7, a high-resolution electron micrograph provides detailed information about the wall structure. The cross-linking between the steric stabilisers on the particles is evident in this image and the wall has an extremely porous structure. Given that the steric stabilisers are themselves pH and temperature sensitive, it is postulated that such a structure would allow the wall to expand and collapse reversibly.

### Considering the Size Control of Particles.

In Table 2 there is detailed a list of the polymers grafted onto the surface of gold nanoparticles and their corresponding molecular weights as measured by NMR and GPC.

TABLE 2

| | | M_{NMR} | M_{GPC} | |
|---|---|---|---|---|
| Polymer type | Chemical | (gmol⁻¹) | (gmol−1) | PDI |
| Homopolymer | P[DMAEMA]₂₈ | 4632 | 6613 | 1.03 |
| Homopolymer | P[DMAEMA]₅₃ | 8553 | 10594 | 1.10 |
| Homopolymer | P[DMAEMA]₈₈ | 13584 | 13997 | 1.12 |
| Homopolymer | P[DMAEMA]₁₀₈ | 16414 | N/A | N/A |
| Diblock copolymer | P[DMAEMA]₄₈- | 25800 | 36397 | 1.04 |
| | P[DEAEMA]₁₀₈ | | | |

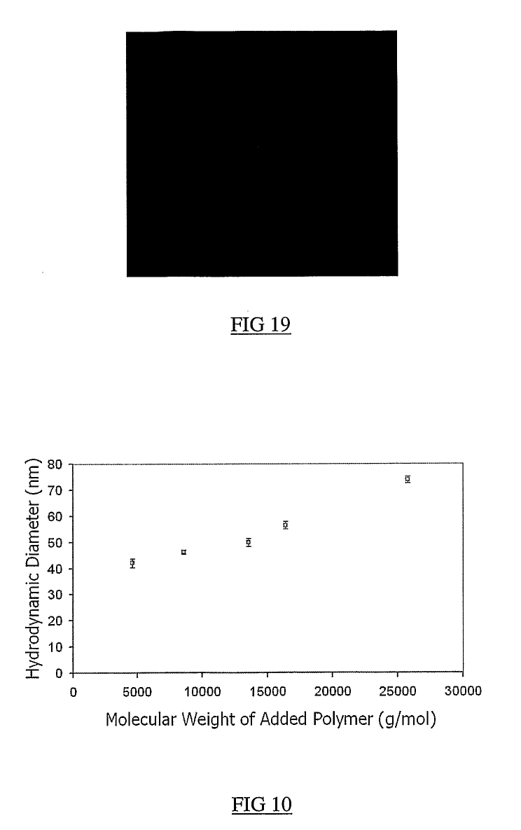

FIG. 10 and Table 2 in combination demonstrate the results obtained for hydrodynamic diameter measurements of gold nanoparticles of 20 nm diameter after coating with polymers of different molecular weight. The hydrodynamic diameter of the sterically stabilised particles increases with the grafted polymer molecular weight. In all cases the solid core of the hybrid system is the same 20 nm solid gold nanoparticles and the difference in the hydrodynamic diameter corresponds solely to the length of the polymer chain extending within the aqueous phase from the solid particle surface. This proves that it is possible to control the size of the particles with high precision.

In the case where the polymer-coated nanoparticles are adsorbed on the surface of the microcapsules, the packing is controlled by the size of the particle/polymer unit and the distance between the solid (gold) cores of the nanoparticles will be approximately equal to the length of the polymer chain.

The pore size within the membrane of the microcapsules corresponds to the size of the interstices between the particles. The size of the interstices is determined by the size of the particles and the distance between them, which is controlled by the polymer size. Hence, it is possible to use the above particles (as measured in FIG. 10) to create microcapsules of increasing pore size.

### Considering the Wettability of Particles.

The wettability of particles can be varied by changing the environmental conditions to which the polymer is responsive to. FIG. 11 illustrates the surface tension measurements as a function of pH for 20 nm gold nanoparticles grafted with a layer of p[DMAEMA]28 on the surface. In FIG. 11, in which we record a decrease of the surface tension as pH increases is recorded, illustrates the adsorption behaviour of 20 nm gold nanoparticles coated with a short homopolymer chain (p[DMAEMA]28) at an air-water interface. At low pH, the homopolymers are protonated and hydrophilic, in which case no particle adsorption is recorded at the oil-water interface. At high pH the polymers deprotonate, become more hydrophobic and drive adsorption of the particles at the air-water interface. It can thus be concluded that the relative wettability of the particle:

(a) is controlled by the environmental stimuli the grafted polymer is responsive to

(b) controls the adsorption of the particles at an air-water or oil-water interface.

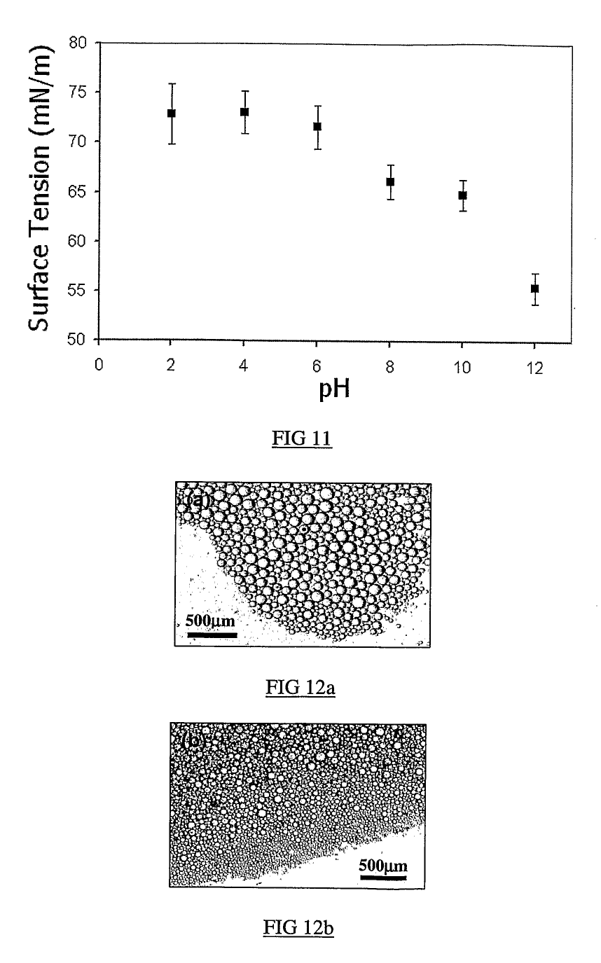

In addition, in FIGS. 12a and 12b which represent optical images (recorded after homogenisation) of emulsions of same oil and water (at pH 10) volumes prepared in the presence of the different concentration of polymer-coated nanoparticles. It is possible to observe that the size of the emulsion droplets obtained decreases with increasing the concentration of nanoparticles in the aqueous phase. This demonstrates directly the successful adsorption of the hybrid nanoparticles to the oil-water interface. A larger interfacial area is stabilised with an increased particle concentration in the system proving the particles are at the interface.

More importantly it is crucial to note that the emulsion droplets prepared in the same conditions, including same particle concentrations, using an aqueous phase at pH 4 were not stable and coalesced instantaneously, indicating very little or no particle adsorption at the oil-water interface in this case.

In FIG. 13 there is illustrated a graph plotting the calculations of energy of desorption of bare nanoparticles at a typical oil-water interface (36 mN/m) as a function of their contact angle for three different particle diameter. The calculations are adapted from Binks and Lumsdon, (Langmuir, 2000, 16, 8622).

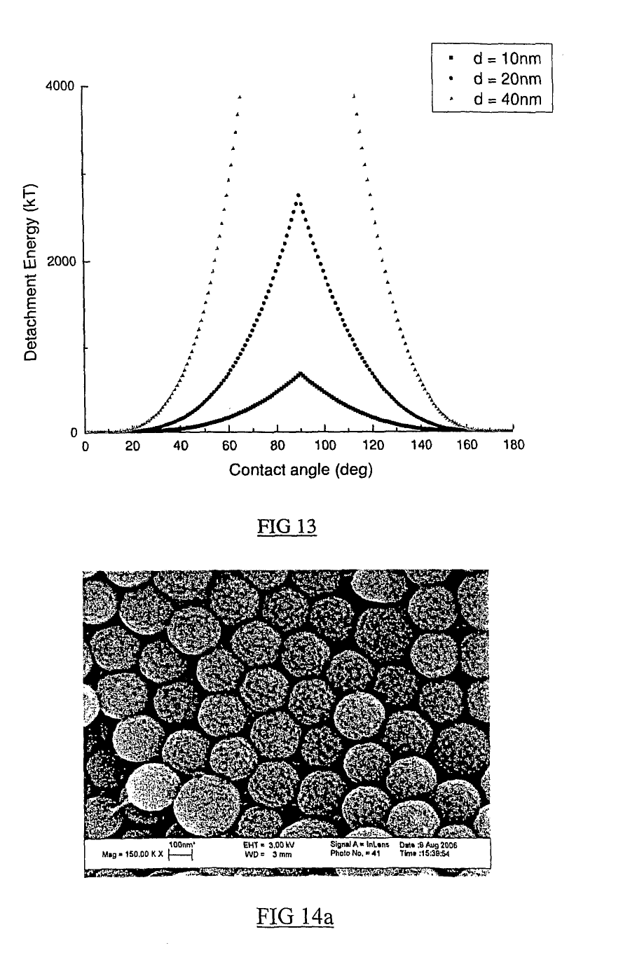

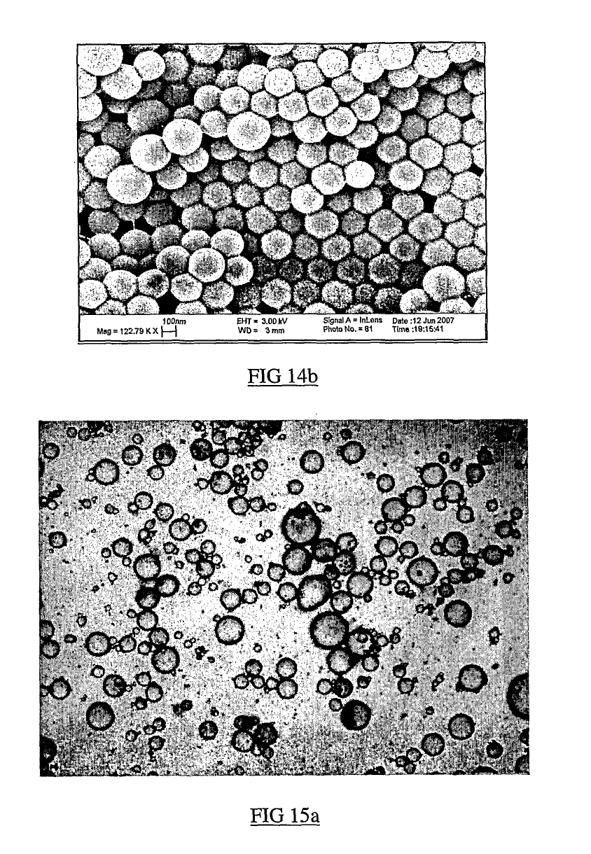

In FIGS. 14a and 14b there is illustrated two images demonstrating variations in crosslinking. In FIG. 14a, a low cross-link density porosity is visible. In FIG. 14b, much more dense linkages between the particles at high cross linker density is visible.

### Considering the pH Response of the Microcapsules.

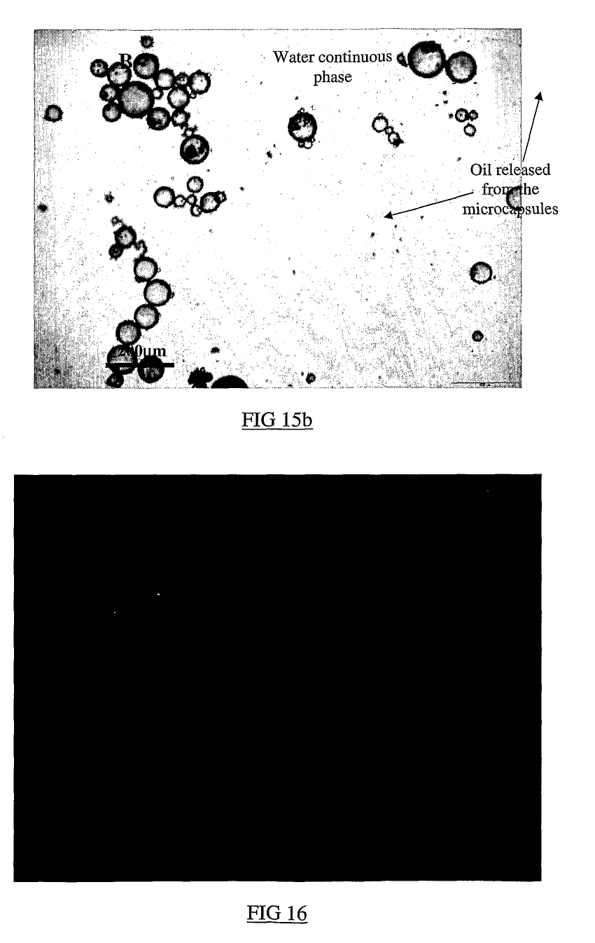

In FIGS. 15a and 15b there is illustrated optical images of the same sample of emulsion droplets stabilised by responsive polymer-coated latex particles redispersed at different pHs. The polymers on the surface of the particles adsorbed at the interface were cross-linked using (BIEE) to render the structures permanent. As the microcapsule sample is redispersed in low pH conditions (pH 3.5), no significant changes are noted (FIG. 15a). When redispersed in a highly basic environment (0.1 M KOH), one can observe oil being released from the microcapsules (FIG. 15b).

When dispersing the microcapsules into a highly basic environment, the polymers on the surface of the particles forming the membrane deprotonate and become highly hydrophobic. This subjects the microcapsule membrane to a high stress as a response to the changes in pH within the system. Under these conditions it is observed that some of the oil contained within the microcapsules being released. This demonstrates the ability of these microcapsules to control the release of encapsulated material upon changes in pH.

### Investigating Dye Loading of the Microcapsules.

In FIG. 16 there is illustrated a fluorescent microscopy image of microcapsules produced from an oil-in-water emulsion stabilised by polymer-coated latex nanoparticles. The oil phase was doped with a hydrophobic dye which was contained within the microcapsule cores after cross-linking of the polymer on the surface of the latex particles adsorbed at the oil-water interface.

FIG. 16 demonstrates that it is possible to encapsulate oil-soluble components within the microcapsules.

In FIG. 17 there is illustrated an optical image of a microcapsule in Isopropyl-alcohol (IPA)/Water mixture (1:1 volume ratio) after complete removal of the oil from within the capsule core.

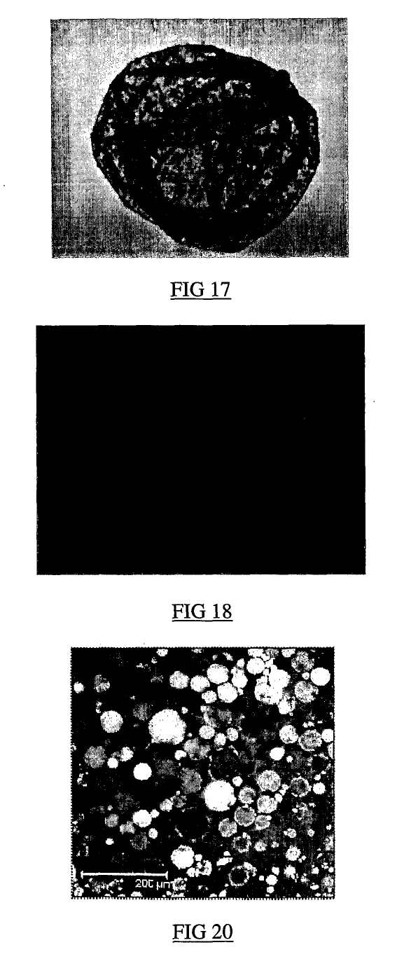

In FIG. 18 there is illustrated an optical image of a microcapsule after complete removal of the oil phase and redispersion in aqueous phase containing 0.1 mM of a 70,000 g·mol⁻¹ dextran molecule labelled with a fluorescent dye.

In FIG. 19 there is illustrated a fluorescent optical image of the same microcapsule as in FIG. 18 after complete removal of the oil phase and redispersion in aqueous phase containing 0.1 mM of a 70,000 g·mol⁻¹ dextran molecule labelled with a fluorescent dye. The inset at the bottom of the image shows fluorescence intensity recorded along the horizontal line drawn across the image through the microcapsule.

FIG. 17 demonstrates that the oil core of the microcapsules can be successfully removed. These microcapsules appear to ‘deflate’ as the oil core is removed by dissolving it in IPA.

FIG. 18 demonstrates that the deflated microcapsules can be refilled in water. In this case, the microcapsules recover their initial spherical structure. This observation shows that the membrane of the microcapsules stays intact following the removal of the oil.

Furthermore, FIG. 20 shows that a high molecular compound can be introduced within the core of the microcapsules since the image demonstrates the same fluorescence intensity in the continuous phase and the microcapsule core.

The above images demonstrate the ability of the capsules to absorb active molecules in the cores. FIG. 20 shows fluorescent molecules adsorbed in the oil within capsules. FIGS. 16 to 19 show the ability of a capsule to be filled, transferred between various solvents, and to respond to a stimulus and thus release their contents.

Therefore, the manufacture of colloidosome-inspired microcapsules using a sterically stabilised colloidal latex is demonstrated. The production of the microcapsules was achieved either through fusion of the latex particles or by chemical cross-linking of the grafted polymer stabilisers. In the melting method, a temperature lower than 100° C. (lower than the glass transition point of particle stabilisation (PS) (˜105° C.)) was applied. The lower temperature (75-90° C.) affords not only a simplified reaction system and preparation process, but also potentially reduces issues surrounding the encapsulation of thermally sensitive ingredients. The permeability and strength of the microcapsules can be adjusted by varying the melting temperature, melting time and number of nanoparticle layers present on the emulsion droplets.

The cross-linking reaction has been carried out from the inside of the droplets by using a cross-linker that is soluble in the dispersed phase. This internal cross-linking approach formed single layered stimulus responsive shell, and allowed the reaction to be carried out at a high concentration.

The interstices between the nanoparticles and ‘breath-ability’ can be controlled by the cross-linking extent through the control of cross-linking agent concentration and/or the amount of PDMA-PMMA grafted on the PS nanoparticles.

1. A microcapsule comprising:
a core; and
a shell, wherein:
the shell comprises a layer of sterically stabilised colloidal particles, and
characterized in that the microcapsule has a mean size from 1 to 100 microns.

2. A microcapsule according to claim 1 wherein the sterically stabilised colloidal particles comprise a material selected from the group consisting of:
metals, metal oxides, and organic lattices.

3. A microcapsule according to claim 1 wherein the sterically stabilised colloidal particles comprise polymer latex particles.

4. A microcapsule according to claim 1 wherein the sterically stabilised colloidal particles further comprise a soluble polymer block.

5. A microcapsule according to claim 4 wherein the soluble polymer block substantially surrounds each colloidal particle and projects outwardly therefrom.

6. A microcapsule according to claim 1 wherein the colloidal particles further comprise a steric stabilizer.

7.-16. (canceled)

17. A microcapsule according to claim 6 wherein the steric stabiliser comprises an end-grafted stabilizer.

18.-20. (canceled)

21. A microcapsule according to claim 1 wherein a first region of the microcapsule comprises different composite properties compared with the bulk of the microcapsule.

22.-31. (canceled)

32. A microcapsule according to claim 6 wherein the steric stabiliser further comprises a cross-linking agent.

33.-37. (canceled)

38. A microcapsule according to claim 1 wherein the mean size of the microcapsule is 1 to 100 μm, more preferably 1 to 20 μm.

39. A microcapsule according to claim 1 wherein the mean size of the microcapsule is controlled by means of a controlled emulsification procedure selected from cross-membrane or rotating membrane emulsification, micro-channel emulsification or capillary extrusion techniques.

40. A microcapsule according to claim 6 wherein the steric stabiliser comprises a glass transition value, Tg in the range of 5 to 90° C.

41. A method for producing microcapsules as claimed in claim 1 using sterically stabilized colloidal particulates as the primary building blocks comprising:
preparing an emulsion through the addition of a first liquid to a second liquid such that the first liquid forms droplets dispersed within the second liquid;
coating the dispersed droplets with sterically stabilized particles whereby the colloidal particulates act as a stabiliser of the liquid-liquid interface; and
securing the sterically stabilized particles on the surface of the droplets to form a system of microcapsules.

42. A method according to claim 41 wherein the sterically stabilized particles are secured in place on the surface (or shell) of the droplets by either heat treatment or chemical cross-linking of the steric stabilizer polymers.

43. A method according to claim 42 wherein when heat treatment is the preferred method, the preferred temperature range is between 70 and 80° C. and the preferred stabilizer comprises PDMA-b-PMMA on the polystyrene (PS) latex system.

44. A method according to claim 43 wherein the preferred droplet concentration is less than 5% by volume.

45. A method according to claim 42 wherein when chemical cross-linking is the preferred method, an internal cross-linking method is employed which fixes the nanoparticles in place as a single layer on the shell or surface of the microcapsule.

46. A method according to claim 45 wherein a preferred cross-linking compound comprises water soluble 1,2-bis(2-iodoethyloxy)ethane.

47. A method according to claim 41 wherein before the emulsification step takes place, a known amount of the preferred cross-linker compound is dissolved in the oil phase.

48. A method according to claim 41 wherein following the cross-linking or heat treatment stage, the system is indefinitely stable.

49. A method according to claim 41 wherein the affinity of the sterically stabilized particles for the surface of droplets is controlled by the relative wettability of the sterically stabilized particles within either phase.

50. A method according to claim 41 wherein a contact angle of 60° to 90° is preferred for the formation of an oil-in-water emulsion.

51. A method according to claim 41 wherein the particles are preferably dispersed in the continuous phase prior to emulsification.

52. A method for producing microcapsules as claimed in claim 1 comprising:
preparing an emulsion comprising droplets;
stabilizing the droplet emulsion by means of colloidal particles, followed by;
linking the particles together to form microcapsules.

53. A method according to claim 52 wherein the membrane emulsification stage of step 1 enables the size of the droplets to be controlled.

54. A method according to claim 52 to control the size of the microcapsules.

55. A method according to claim 52 for producing microcapsules which comprise colloidal particles that:
retain the inherent properties of the core particle which has not itself undergone fusion; and
allow fusion to take place at much reduced temperatures thereby allowing heat-sensitive ingredients to be incorporated into the microcapsules.

56. A method according to claim 52 wherein the porosity of the microcapsule shell wall can be controlled by means of variation of particle concentration and the time and/or temperature of the fusion reaction.

57. A method according to claim 52 for producing ‘soft shell’ microcapsules further comprising:
adding a chemical cross-linking agent to the emulsion, wherein the chemical crosslinker comprises water soluble 1,2-bis(2-iodoethyloxy)ethane and has no solubility in the continuous phase.

58. A method according to claim 57 wherein the cross-linking step occurs from within the droplets allowing the production of microcapsules at high volume fraction of emulsion droplets.

59. (canceled)

60. (canceled)

61. A microcapsule according to claim 1 further comprising as additive selected from; biocides, perfumes, disperants and colourants.
